(19) United States
(12) Patent Application Publication
(10) Pub. No.: US 2026/0071101 A1
(43) Pub. Date: Mar. 12, 2026

(54) DEBONDABLE ADHESIVE SYSTEMS

(71) Applicant: Henkel AG & Co. KGaA, Duesseldorf (DE)

(72) Inventors: Bethany A. Kalach, West Hartford, CT (US); Wenhua Zhang, Farmington, CT (US); Jianping Liu, So. Glastonbury, CT (US); Christopher Martino, West Hartford, CT (US); Zheng Lu, South Glastonbury, CT (US)

(21) Appl. No.: 19/389,285

(22) Filed: Nov. 14, 2025

Related U.S. Application Data
(63) Continuation-in-part of application No. PCT/US2024/029612, filed on May 16, 2024.
(60) Provisional application No. 63/466,881, filed on May 16, 2023.

(51) Int. Cl. C09J 11/04; C09J 11/06; C09J 163/00

(52) U.S. Cl. CPC C09J 11/04; C09J 11/06; C09J 163/00

(57) ABSTRACT

Provided herein is a debondable adhesive system.

### BACKGROUND

### Field

Provided herein is a debondable adhesive system.

### Brief Description of Related Technology

Debondable adhesive systems have been pursued for quite some time. Such systems are perceived to be useful where imprecise positioning of substrates to be bonded has occurred, when an incorrect substrate was chosen to be bonded, and/or in instances where one of the substrates to be bonded has have been determined to be defective and replacement needed.

Despite the efforts of many in this area, there remains a long felt, yet unmet need to provide a suitable system having wide applicability. It is believed that such a system would be well received by industry and consumers alike.

Such a system has yet to be discovered. Until now.

### SUMMARY

Provided herein in one embodiment is an ionic liquid-infused particle. Put another way, provided herein is a composition comprising an ionic liquid and a particle, wherein the ionic liquid is infused in or on the particle.

In one aspect, the ionic liquids described herein are a type of liquid made up of positively and negatively charged ions. They have a low melting point (such as less than about 100° C.) and are often liquid at or around room temperature.

In another aspect, ionic liquids are compounds made up of dissolved positively and negatively charged ions. In this aspect, the ionic compound itself may be solid at or around room temperature and may be dissolved in a solvent forming an ionic liquid. The solvent chosen may be polar (or non or less polar) and protic or aprotic. When dissolved in such solvents, the compounds may liberate their (positively and negatively charged) ions.

In yet another aspect, the ionic liquids are composed either of a salt having a Group IA or IIA element as a cation and a Group VIIA element or a compound comprising one or more Group VIIA element(s) as an anion; optionally, an organic solvent; and optionally, water.

In still another aspect, the inorganic ionic liquid may be a salt having an alkali metal such as lithium or sodium, alkaline earth metal such as beryllium or magnesium, transition metal such as iron or copper, or other metallic element such as aluminum or zinc as a cation. The ionic liquid may be a salt having a halide such as fluorine or chlorine, Group 16 element such as oxygen or sulfur, Group 15 element such as nitrogen or phosphorous, or other nonmetallic elements such as carbon or silicon as an anion.

In still another aspect, the organic ionic liquid may be a salt having an organic positively charged cation such as imidazolium, pyridinium, phosphonium, ammonium, morpholinium, allyl cation, or benzyl cation. The ionic liquid may be a salt having an organic negatively charged anion such as tetrafluoroborate, hexafluorophosphate, trifluoromethanesulfonate (also known as triflate), bis(trifluoromethyl sulfonyl)imide (“TFSI”), acetate, carboxylate, phenolate, or sulfonate.

In another embodiment, provided herein is a curable composition comprising:
A curable component [such as (meth)acrylates, epoxies, alkoxy-functionalized siloxanes, silane-functionalized monomers, oligomers and polymers, isocyanato-functionalized monomers, oligomers and polymers and combinations thereof); and
An ionic liquid-infused particle as so described.

In another embodiment, provided herein is a method of debonding one or more substrates bonded together by an adhesive composition, comprising the steps of:
Providing an assembly comprising two or more electrically conductive substrates adhesively bonded together at inwardly facing surfaces by a reaction product of the curable composition as so described;
Providing a power supply, wherein a first connection is made from the power supply to a first conductive substrate and a second connection is made from the power supply to a second conductive substrate;
Applying to the electrically conductive substrates about 3 volts to about 75 volts, such as about 30 volts of DC current from the power supply for a period of time of about 0.1 seconds to about 3 hours, such as about 5 minutes to about 3 hours, at room temperature; and
Separating at least one electrically conductive substrate from the reaction product.

In another embodiment, provided herein is a method of reversibly adhesively bonding one or more substrates together with a curable composition, comprising the steps of:
Providing one or more electrically conductive substrates;
Providing a curable composition as so described onto at least one surface of at least one of the one or more electrically conductive substrates;
Mating the at least one surface on which is disposed the curable composition with another surface of an electrically conductive substrate and exposing the mated surfaces to conditions favorable to cure the curable composition thereby forming an adhesively bonded assembly;
Providing a power supply and connecting the power supply to the adhesively bonded assembly, wherein a first connection is made from the power supply to a first conductive substrate and a second connection is made from the power supply to a second conductive surface;
Applying to the electrically conductive substrates about 3 volts to about 75 volts, such as about 30 volts of DC current from the power supply for a period of time of about 0.1 seconds to about 3 hours, such as about 5 minutes to about 3 hours, at room temperature; and
Separating at least one electrically conductive substrate from the cured composition.

### BRIEF DESCRIPTION OF THE FIGURE

FIG. 1 depicts a bar chart of relative strength (measured in MPa) of control formulations and a formulation according to the present invention.

### DETAILED DESCRIPTION

As noted above, provided herein in one embodiment is an ionic liquid-infused particle. Put another way, provided herein is a composition comprising an ionic liquid and a particle, wherein the ionic liquid is infused in or on the particle.

In one aspect, the ionic liquids described herein are a type of liquid made up of positively and negatively charged ions. They have a low melting point (such as below about 100° C.) and are often liquid at or around room temperature.

In another aspect, ionic liquids are compounds made up of dissolved positively and negatively charged ions. In this aspect, the ionic compound itself may be solid at or around room temperature and may be dissolved in a solvent forming an ionic liquid. The solvent chosen may be polar (or non or less polar) and protic or aprotic. When dissolved in such solvents, the compounds may liberate their (positively and negatively charged) ions.

In yet another aspect, ionic liquids are composed either of a salt having a Group IA or IIA element as a cation and a Group VIIA element or a compound comprising one or more Group VIIA element(s) as an anion.

In still another aspect the inorganic ionic liquid may be a salt having an alkali metal such as lithium or sodium, alkaline earth metal such as beryllium or magnesium, transition metal such as iron or copper, or other metallic element such as aluminum or zinc as a cation. The ionic liquid may be a salt having a halide such as fluorine or chlorine, Group 16 element such as oxygen or sulfur, Group 15 element such as nitrogen or phosphorous, or other nonmetallic elements such as carbon or silicon as an anion.

In still another aspect the organic ionic liquid may be a salt having an organic positively charged cation such as imidazolium, pyridinium, phosphonium, ammonium, morpholinium, allyl cation, or benzyl cation. The ionic liquid may be a salt having an organic negatively charged anion such as tetrafluoroborate, hexafluorophosphate, trifluoromethanesulfonate (also known as triflate), bis(trifluoromethylsulfonyl)imide (“TFSI”), acetate, carboxylate, phenolate, or sulfonate.

The organic solvent may be present, and when present may be selected from a polyethylene glycol, such as PEG 400, PEG 200, or PEG 600, tetraglyme, tetrahydrofuran (“THF”), dimethyl formamide (“DMF”), hydroxy ethyl acrylate (“HEA”), hydroxy ethyl methacrylate (“HEMA”), methacrylic acid (“MAA”), alcohols, such as ethanol or isopropanol, acetone, or acrylamide.

Water may be present too.

In the ionic liquid the salt may represent all of the ionic liquid, particularly when the salt is liquid at room temperature. Or the salt may be present in the ionic liquid in an amount of from about 0.1 percent by weight to about 99.9 percent by weight, such as about 1 percent by weight to about 50 percent by weight, desirably about 5 percent by weight to about 35 percent by weight, such as about 15 percent by weight to about 30 percent by weight, optionally together with an organic solvent and/or water. Where the organic solvent is present in the ionic liquid in an amount of from about 25 percent by weight to about 85 percent by weight, such as about 50 percent by weight to about 75 percent by weight, desirably about 55 percent by weight to about 65 percent by weight. And where water is present in the ionic liquid in an amount of from about 1 percent by weight to about 50 percent by weight, such as about 5 percent by weight to about 25 percent by weight, desirably about 10 percent by weight to about 20 percent by weight.

The absorbency of the particle benefits the present invention. Whether viewed in terms of surface area (such as determined by BET measurements), or porosity or surface affinity, the extent to which the ionic liquid may bind or become associated with particle influences performance, particularly in terms of debondability after an adhesion bond has been formed and a voltage is applied to that bond.

The particle is typically in the size range of about 50 nm to about 200 microns. Absorbency is typically defined by surface area, with at least about 20 m²/g to about 500 m²/g (as determined by BET measurements) being desirable. The particle may be characterized to have a tapped (or tamped) density, which is a measure of the bulk density of a powder or granular material, and is ordinarily in the range of about 0.01 g/mL to about 3.0 g/mL.

The ionic liquid should be present in the porosity of, surface on and/or interstices of the layers of the ionic liquid-infused particle in an amount of from about 1 percent by weight to about 500 percent by weight, depending on the design or construction of the particle itself is present. Desirably, the ionic liquid should be present in an amount of from about 5 percent by weight to about 200 percent by weight, such as about 25 percent by weight to about 125 percent by weight, and more desirably 50 percent by weight to about 100 percent by weight in the ionic liquid-infused particle.

The particle may be inorganic or organic. For instance, the particle may be silica, such as fused silica, calcium carbonate, carbon black, alumina, molecular sieve, clay, titanium dioxide, mica, cellulose, talc, graphite, or glass particles. Or the particle may be sawdust, cellulose, polymethyl methacrylate (“PMMA”), polysulfone (“PS”), polypropylene (“PP”), polyethylene terephthalate (“PET”), or nylon.

Commercially available examples of a silica particle from AGC Chemicals America Inc., Exton, PA, under the trade name SOLESPHERE, such as Solesphere H-51 (5 μm size, 800 m²/g surface area, 150 mL/100 g oil absorbance), L-51 (5 μm size, 300 m²/g surface area, 150 mL/100 g oil absorbance), and H-121 (12 μm size, 800 m²/g surface area, 150 mL/100 g oil absorbance and those from Evonik, Sipernat 22 (120 μm size, 180 m²/g surface area, 235 mL/100 g oil absorbance), 50S (18 μm size, 500 m²/g surface area, 280 mL/100 g oil absorbance), and 500LS (10.5 μm size, 500 m²/g surface area, 270 mL/100 g oil absorbance).

In another embodiment as noted above provided herein is a curable composition comprising:
A curable component [such as (meth)acrylates, epoxies, alkoxy-functionalized siloxanes, silane-functionalized monomers, oligomers and polymers, isocyanato-functionalized monomers, oligomers and polymers and combinations thereof]; and
An ionic liquid-infused particle as so described.

The (meth)acrylates may be selected from mono-functional (meth)acrylates, di-functional (meth)acrylates or polyfunctional (meth)acrylates, which may be monomeric, oligomeric or polymeric. Thus, di-functional (meth)acrylates or polyfunctional (meth)acrylates may have the (meth)acrylate functionality at the terminal ends or pendant along a chain or backbone between the terminus thereof.

The (meth)acrylates may be represented by H₂C═CGCO₂R¹, wherein G is selected from H, halogen and alkyl having from 1 to about 4 carbon atoms, and R¹ is selected from alkyl, cycloalkyl, alkenyl, cycloalkenyl, alkaryl, and aryl groups having from 6 to about 16 carbon atoms, with or without substitution or interruption by a member selected from the group consisting of silane, silicon, oxygen, halogen, carbonyl, hydroxyl, ester, carboxylic acid, urea, urethane, carbamate, amine, amide, sulfur, sulfonate and sulfone.

More specifically, the (meth)acrylates may be selected from silicone (meth)acrylates, polyethylene glycol di(meth)acrylates, tetrahydrofuran (meth)acrylates and di(meth)acrylates, hydroxyethyl (meth)acrylate, hydroxypropyl (meth)acrylate, isobornyl acrylate, hexanediol di(meth)acrylate, trimethylol propane tri(meth)acrylates, diethylene glycol di(meth)acrylates, triethylene glycol di(meth)acrylates, tetraethylene diglycol di(meth)acrylates, diglycerol tetra(meth)acrylates, tetramethylene di(meth)acrylates, ethylene di(meth)acrylates, neopentyl glycol di(meth)acrylates, butane diol di(meth)acrylates, bisphenol-A-(meth)acrylates, ethoxylated bisphenol-A-(meth)acrylates, bisphenol-F-(meth)acrylates, ethoxylated bisphenol-F-(meth)acrylates, bisphenol-A di(meth)acrylates, ethoxylated bisphenol-A-di(meth)acrylates, bisphenol-F-di(meth)acrylates, and ethoxylated bisphenol-F-di(meth)acrylates.

Even more specifically, the (meth)acrylates may be selected from commercially available ones including multifunctional (meth)acrylates [such as SR368 (trifunctional acrylate) and/or SR248 (neopentyl glycol dimethacrylate), each from Arkema Inc.], monofunctional (meth)acrylates [such as SR506A (isobornyl acrylate), from Arkema Inc.], 2-(4-benzoyl-3-hydroxyphenoxy)ethyl acrylate, BAC-45 (polybutadiene diacrylate, from Osaka Organic Chemical Industry Ltd.), polybutadiene diacrylate (CN302 or CN303 from Arkema Inc.), polybutadiene urethane acrylate (SUO-8130LVH from SHIN-A T&C), and combinations thereof.

The (meth)acrylates should be present in an amount of about 1 percent by weight to about 95 percent by weight, such as about 25 percent by weight to about 80 percent by weight, desirably about 50 percent by weight to about 75 percent by weight based on the total weight of the composition.

The epoxies may be mono-functional epoxies, di-functional epoxies or polyfunctional epoxies, which may be monomeric, oligomeric or polymeric. Thus, di-functional epoxies or polyfunctional epoxies may have the epoxy functionality at the terminal ends or pendant along a chain or backbone between the terminus thereof.

For instance, the epoxies may include the mono-functional epoxy compounds: C₄-C₂₈ alkyl glycidyl ethers; C₂-C₂₈ alkyl- and alkenyl-glycidyl esters; and C₁-C₂₈ alkyl- and mono-phenol glycidyl ethers; as well as the multifunctional epoxy compounds: polyglycidyl ethers of pyrocatechol, resorcinol, hydroquinone. 4,4′-dihydroxydiphenyl methane (or bisphenol F, such as RE-303-S or RE-404-S available commercially from Nippon Kayuku, Japan), 4,4′-dihydroxy-3,3-dimethyldiphenyl methane, 4,4′-dihydroxydiphenyl dimethyl methane (or bisphenol A), 4,4′-dihydroxydiphenyl methyl methane, 4,4′-dihydroxydiphenyl cyclohexane, 4,4-dihydroxy-3,3′-dimethyldiphenyl propane, 4,4′-dihydroxydiphenyl sulfone, and tris(4-hydroxyphenyl) methane; polyglycidyl ethers of transition metal complexes; chlorination and bromination products of the above-mentioned diphenols; polyglycidyl ethers of novolacs; polyglycidyl ethers of diphenols obtained by esterifying ethers of diphenols obtained by esterifying salts of an aromatic hydrocarboxylic acid with a dihaloalkane or dihalogen dialkyl ether; polyglycidyl ethers of polyphenols obtained by condensing phenols and long-chain halogen paraffins containing at least two halogen atoms; N,N′-diglycidyl-aniline; N,N′-dimethyl-N,N′-diglycidyl-4,4′-diaminodiphenyl methane; N,N,N′,N′-tetraglycidyl-4,4-diaminodiphenyl methane; N,N′-diglycidyl-4-aminophenyl glycidyl ether; N,N,N′,N′-tetraglycidyl-1,3-propylene bis-4-aminobenzoate; phenol novolac epoxy resin; cresol novolac epoxy resin; and combinations thereof.

Among the commercially available epoxies useful as the epoxy component include polyglycidyl derivatives of phenolic compounds, such as those available from Resolution Performance, under the EPON tradename, such as EPON 1009F [bisphenol A epoxy resin (CAS No. 25036-25-3)], EPON 1001F, EPON 1002F, EPON 1004F, EPON 1007F. EPON 3001, EPON 3002, EPON 2002, EPON 2003, EPON 2004, EPON 2005, EPON 2012, EPON 2014, EPON 2024, and EPON 2042; from Dow Chemical Co. under the DER trade designation, such as DER 331, DER 332, DER 383, DER 354, and DER 542; from Huntsman Corp. under the ARALDITE tradename, such as ARALDITE [phenol-4,4′-(1-methylethylidene)bis with (chloromethyl) oxirane (CAS No. 25068-38-6)], ARALDITE ECN 1299 [formaldehyde, polymer with (chloromethyl) oxirane and 2-methylphenol, melting point 85-100° C. (CAS No. 29690-82-2)] and ARALDITE ECN 1285 [formaldehyde, polymer with (chloromethyl) oxirane and 2-methylphenol, melting point 80-90° C. (CAS No. 29690-82-2)], and ARALDITE CT 7097 US [(phenol, 4-(1,1-dimethylethyl), polymer with (chloromethyl) oxirane and 4,4-(1-(1-methylethylidene)bis, melting point 113-123° C. (CAS No. 67924-34-9)]; and from Nippon Kayaku, Japan, BREN-S. Other suitable epoxy resins include polyepoxides prepared from polyols and the like and polyglycidyl derivatives of phenol-formaldehyde novolacs, the latter of which are available commercially from Dow Chemical Company under the tradename DEN, such as DEN 431, DEN 438, and DEN 439.

Polyglycidyl adducts of amines, aminoalcohols and polycarboxylic acids are also useful in this invention, commercially available resins of which include GLYAMINE 135, GLYAMINE 125, and GLYAMINE 115 from BP Chemicals, LTD.; ARALDITE MY 720, ARALDITE MY 721, ARALDITE MY 0500, and ARALDITE MY 0510 from Huntsman Corp.

The epoxies may be present in an amount of about 1 percent by weight to about 95 percent by weight, such as about 25 percent by weight to about 80 percent by weight, desirably about 50 percent by weight to about 75 percent by weight based on the total weight of the composition.

The alkoxy-functionalized siloxanes may be selected from mono-functional alkoxy-functionalized siloxanes, di-functional alkoxy-functionalized siloxanes or polyfunctional alkoxy-functionalized siloxanes, each of which may be monomeric, oligomeric or polymeric. Thus, di-functional alkoxy-functionalized siloxanes or polyfunctional alkoxy-functionalized siloxanes may have the alkoxy functionality at the terminal ends or pendant along a chain or backbone between the terminus thereof.

Commercially available examples of such alkoxy-functionalized siloxanes include those from Wacker, such as those under the trade names SILRES, GENIOSIL and ELASTOSIL, for instance Silres BS 220, Geniosil XM 20, Elastosil LR 3003/60 and Silres® IC 235; Dow Corning, such as Dow Corning 200 and Dow Corning 890-SL; Momentive, such as Silopren LSR 27XX Series and Silplus HCR Series; and Shin-Etsu, such as KF-96, X-34-202, and KR-5200.

The silane-functionalized monomers may be selected from mono-functional silane-functionalized monomers, di-functional silane-functionalized monomers or polyfunctional silane-functionalized monomers, which may be alternatively oligomeric or polymeric as well (though for simplicity are referred to herein as monomers). Thus, di-functional silane-functionalized monomers or polyfunctional silane-functionalized monomers may have the silane functionality at the terminal ends or pendant along a chain or backbone between the terminus thereof.

Commercially available examples of such silane-functionalized monomers include those from Kaneka such as MS polymer, S203H, S303H, S227, and S327; and Wacker, such as Geniosil STP-E10, STP-E15, STP-E30, and STP-E35.

The silane-functionalized monomers may be present in an amount of about 1 percent by weight to about 95 percent by weight, such as about 25 percent by weight to about 80 percent by weight, desirably about 50 percent by weight to about 75 percent by weight based on the total weight of the composition.

The isocyanato-functionalized monomers and oligomers may be selected from mono-functional isocyanato-functionalized monomers, di-functional isocyanato-functionalized monomers or polyfunctional isocyanato-functionalized monomers, which may be alternatively oligomeric or polymeric as well (though for simplicity are referred to herein as monomers). Thus, di-functional isocyanato-functionalized monomers or polyfunctional isocyanato-functionalized monomers may have the isocyanato functionality at the terminal ends or pendant along a chain or backbone between the terminus thereof.

The isocyanato-functionalized component comprises monomeric or polymeric diphenyl methane diisocyanate (“MDI”), isocyanate functional pre-polymer, or mixtures thereof. Such components are understood to have on average two or more isocyanate groups. Polymeric MDI is a known commercially available variant of MDI. It is not a pre-polymer but rather “linked” MDI molecules. Polyisocyanate components that are 100% monomeric polyisocyanates do not show the surprising advantages. However, polyisocyanate components comprising up to about 50 percent by weight monomeric polyisocyanates do show advantageous properties. In some embodiments the polyisocyanate component comprises about 50 percent by weight or less monomeric polyisocyanates by weight of the polyisocyanate component. Monomeric MDI and its isomers are preferred and may be used exclusively if monomeric polyisocyanates are present in the polyisocyanate component. In some embodiments the polyisocyanate component preferably comprises polymeric MDI, a MDI pre-polymer, monomeric MDI or mixtures thereof.

Some suitable polyisocyanates include hydrogenated MDI (“HMDI”), xylylene diisocyanate (“XDI”), tetramethyl xylylene diisocyanate (“TMXDI”), 4,4′-diphenyl dimethyl-methane diisocyanate, di- and tetraalkylene diphenylmethane diisocyanate, 4,4′-dibenzyl diisocyanate, 1,3-phenylene diisocyanate, 1,4-phenylene diisocyanate, 1-methyl-2,4-diisocyanatocyclohexane, 1,6-diiso-cyanato-2,2,4-trimethyl hexane, 1,6-diisocyanato-2,4,4-trimethyl hexane, 1-isocyanatomethyl-3-isocyanato-1,5,5-trimethyl cyclohexane (“IPDI”), chlorinated and brominated diisocyanates, phosphorus-containing diisocyanates, 4,4′-diisocyanatophenyl perfluoroethane, tetramethoxybutane-1,4-diisocyanate, butane-1,4-diisocyanate, hexane-1,6-diisocyanate (“HDI”), dicyclohexylmethane diisocyanate, cyclo-hexane-1,4-diisocyanate, ethylene diisocyanate, phthalic acid-bis-isocyanatoethyl ester; diisocyanates containing reactive halogen atoms, such as 1-chloromethylphenyl-2,4-diisocyanate, 1-bromomethylphenyl-2,6-diisocyanate or 3,3-bis-chloromethylether4,4′-diphenyl diisocyanate, trimethyl hexamethylene diisocyanate, 1,4-diisocyanatobutane, 1,12-diisocyanatododecane, dimer fatty acid diisocyanate, tetramethylene diisocyanate, hexamethylene diisocyanate, undecane diisocyanate, dodecamethylene diisocyanate, 2,2,4-trimethylhexane-2,3,3-trimethylhexamethylene diisocyanate, 1,3-cyclohexane diisocyanate, 1,4-cyclohexane diisocyanate, 1,3- and 1,4-tetramethyl xylene diisocyanate, isophorone, 4,4-dicyclohexylmethane, tetramethylxylylene (TMXDI) and lysine ester diisocyanate.

Some suitable polyisocyanates include aromatic polyisocyanates. Aromatic polyisocyanates are characterized by the fact that the isocyanate groups are positioned directly on the benzene ring. Suitable aromatic diisocyanates include MDI and its isomers, toluene diisocyanate (“TDI”) and its isomers and naphthalene-1,5-diisocyanate (“NDI”).

Some other suitable polyisocyanates include sulfur-containing polyisocyanates that are obtained, for example, by reaction of 2 mol hexamethylene diisocyanate with 1 mol thiodiglycol or dihydroxydihexyl sulfide.

Aliphatic polyisocyanates with two or more isocyanate functionality formed by biuret linkage, uretdione linkage, allophanate linkage, and/or by trimerization are suitable.

The polyisocyanate component encompasses a single polyisocyanate or the mixture of two or more polyisocyanates.

Useful polyisocyanates include diisocyanates such as MDI, TDI, 1,4-diisocyanatobenzene (“PPDI”); 2,4′-diphenylmethane diisocyanate; 1,5-naphthalene diisocyanate, polymeric MDI, bitolylene diisocyanate, 1,3-xylene diisocyanate, p-TMXDI, 1,6-diisocyanato-2,4,4-trimethylhexane, CHDI, BDI, H₆XDI, IPDI, H₁₂MDI, polymeric versions of any of the above such as polymeric MDI, modified versions of the same such as allophanates, carbodiimides and biurets, and mixtures thereof.

Commercially available examples of such isocyanato-functionalized monomers, oligomers, polymers and pre-polymers include those from Evonik, such as those sold under the trade name VESTANAT, including Vestanat IPDI, TMDI, and A 95; and from Covestro, those sold under the trade names DESMODUR and MONDUR, including Desmodur VK5, Desmodur 44V, Desmodil, and Mondur MR.

The isocyanato-functionalized monomers, oligomers, polymers and pre-polymers may be present in an amount of about 1 percent by weight to about 95 percent by weight, such as about 25 percent by weight to about 80 percent by weight, desirably about 50 percent by weight to about 75 percent by weight based on the total weight of the composition.

The composition may also include a curative, such as peroxides, nitrogen-containing compounds (like amines), catalysts, and azo compounds.

Examples of peroxides include hydrogen peroxide, benzoyl peroxide, cumene hydroperoxide, sodium peroxide, acetyl peroxide, di-tert-butyl peroxide, tert-butyl hydroperoxide, calcium peroxide, and peracetic acid, with cumene hydroperoxide and sodium peroxide being desirable.

Examples of nitrogen-containing compounds suitable as a curative, particularly for use with epoxies, include amines, such as those available commercially from BASF Corporation under the trade name JEFFAMINE and BAXXODUR, such as Jeffamine D400, M600, and M1000, and Baxxodur EC130, EC 303, and EC 310; and ethylenediamine (“EDA”), diethylenetriamine (“DETA”), and triethylenetetramine (“TETA”).

Examples of catalysts include tin, potassium, alumina, zirconium dioxide, copper chromate, and sodium hydroxide.

Examples of azo compounds include 2,2′-azobis(2-methylpropionitrile), 2,2′-azobis(isobutyronitrile), 2,2′-azobis(2,4-dimethylvaleronitrile), and 2,2′-azobis(2-methylbutyronitrile).

The curable component may be present in an amount of from about 25 percent by weight to about 99 percent by weight of the composition; the curative may be present in an amount of from about 0.1 percent by weight to about 50 percent by weight of the composition; the ionic liquid-infused particle may be present in an amount of from about 0.9 percent by weight to about 70 percent by weight of the composition, wherein the total amount is 100 percent by weight of the composition.

Alternatively, the curable component may be present in an amount of from about 25 percent by weight to about 95 percent by weight of the composition; the curative may be present in an amount of from about 5 percent by weight to about 40 percent by weight of the composition; and the ionic liquid-infused particle may be present in an amount of from about 2 percent by weight to about 65 percent by weight of the composition, wherein the total amount is 100 percent by weight of the composition.

The composition may be useful as an adhesive or a coating.

In another embodiment provided herein is a method of debonding one or more substrates bonded together by an adhesive composition, comprising the steps of:
Providing an assembly comprising two or more electrically conductive substrates adhesively bonded together at inwardly facing surfaces by a reaction product of the curable composition as so described;
Providing a power supply, wherein a first connection is made from the power supply to a first conductive substrate and a second connection is made from the power supply to a second conductive substrate;
Applying to the electrically conductive substrates about 3 volts to about 75 volts, such as about 30 volts, of DC current from the power supply for a period of time of about 0.1 seconds to about 3 hours, such as about 5 minutes to about 3 hours, at room temperature;
Separating at least one electrically conductive substrate from the reaction product.

In practicing this method, the at least one electrically conductive substrate may be separated from the reaction product leaving little to no residual reaction product on the surface of the substrate so separated.

In practicing this method, about less than 50% of the force may be used to separate the at least one electrically conductive substrate from the reaction product than is needed in the absence of the applied voltage.

Moreover, in practicing this method, at least one of the substrates to be separated will separate under such conditions with little to no residual cured curable composition remaining on the substrate(s).

In another embodiment provided herein is a method of reversibly adhesively bonding one or more substrates together with a curable composition, comprising the steps of:
Providing one or more electrically conductive substrates;
Providing a curable composition as so described onto at least one surface of at least one of the one or more electrically conductive substrates;
Mating the at least one surface on which is disposed the curable composition with another surface of an electrically conductive substrate and exposing the mated surfaces to conditions favorable to cure the curable composition thereby forming an adhesively bonded assembly;
Providing a power supply and connecting the power supply to the adhesively bonded assembly, wherein a first connection is made from the power supply to a first conductive substrate and a second connection is made from the power supply to a second conductive surface;
Applying to the electrically conductive substrates about 3 volts to about 75 volts, such as about 30 volts of DC current from the power supply for a period of time of about 0.1 seconds to about 3 hours, such as about 5 minutes to about 3 hours, at room temperature;
Separating at least one electrically conductive substrate from the cured composition.

The examples that follow are presented for illustrative purposes.

### EXAMPLES

In these examples, the following constituents listed in Table 1 below were used to create the compositions evaluated.

TABLE 1

| | | Sample 1 | Sample 2 | Sample 3 | Sample 4 |
|---|---|---|---|---|---|
| | | No Ab. | Ab. | Ionic | Ab. Particles |
| | | Particles or | Particles | Liquid | and Ionic |
| | Material | Ionic Liquid | Only | A Only | Liquid A |
| Part A | Epoxy resin | 91.4% | 44.54% | 40.58% | 29.61% |
| (2 parts) | Reactive diluent | 8.6% | 4.19% | 3.82% | 2.79% |
| Part B | 4,7,10- | 44.12% | 10.75% | 9.79% | 7.15% |
| (1 part) | Trioxatridecane | | | | |
| | Polyetheramine | 55.88% | 13.61% | 12.41% | 9.05% |
| | D 2000 | | | | |
| | Ionic Liquid A | — | — | 33.4% | — |
| | Absorbent particle | — | 26.90% | — | — |
| | Absorbent particle | | | — | 51.4% |
| | soaked with Ionic | | | | |
| | Liquid A | | | | |

Each of Samples 1-4 were prepared from the materials listed in the amounts noted in Table 1 (on a percent by weight basis). Here, Ionic Liquid A is a salt compound partially dissolved in water, then further dissolved in a solvent. The composition of the ionic liquid is 30 percent by weight of lithium perchlorate dissolved in 10 percent water by weight and 60 percent PEG 400 by weight. The ionic compound was added to the solvent at room temperature with speed mixing for a period of time of about 3 minutes or until no discernable ionic compound was visualized.

The so formed Ionic Liquid A was then added to the absorbent particles (SOLESPHERE L-51) to make the ionic liquid infused particles used in Sample 4 in an amount of 35 percent by weight ionic liquid to 65 percent by weight particles. The mixture was speed mixed at room temperature for a period of time of about 1 minute or until all liquid was absorbed. The ionic liquid infused particles were determined to contain 1.4 grams of ionic liquid per gram of particle.

Samples 1-4 were then prepared by mixing together the Parts A and B of the epoxy adhesive system, and in Samples 2-4 either particles (Sample 2), ionic liquid (Sample 3) or ionic liquid infused particles (Sample 4) were added. The samples, once prepared, were dispended onto galvanized steel substrates, which after cleaning were then mated and allowed to cure at room temperature for a period of time of about 24 hours to form bonded assemblies. The assemblies were each made in triplicate.

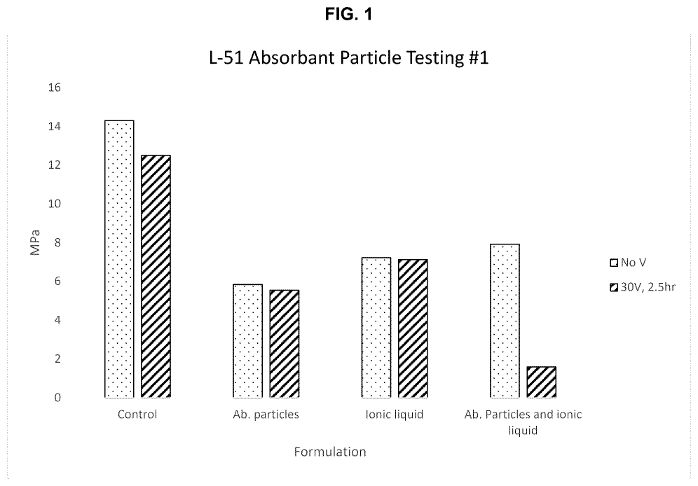

After the assemblies were formed, a power supply was attached to the substrates and a voltage applied. The force required to separate the substrates is shown below in Table 2 and depicted visually in FIG. 1.

TABLE 2

| | | | | | | | | Sample |
|---|---|---|---|---|---|---|---|---|
| | | | | | | | Sample | 4-2 |
| | | | Sample | Sample | Sample | Sample | 4-1 | Abs. |
| | | | 2-1 | 2-2 | 3-1 | 3-2 | Ab. | Particles |
| | Sample | Sample | Abs. | Abs. | Ionic | Ionic | Particles | and |
| | 1-1 | 1-2 | Particles | Particles | Liquid A | Liquid A | and Ionic | Ionic |
| | Control | Control | Only | Only | Only | Only | Liquid A | Liquid |
| Physical | No | 30 V, | No | 30 V, | No | 30 V, | No | A 30 V, |
| Property | Voltage | 2.5 hr | Voltage | 2.5 hr | Voltage | 2.5 hr | Voltage | 2.5 hr |
| Strength | 13.6 | 17 | 5.53 | 5.75 | 6.45 | 5.27 | 8.08 | 1.5 |
| (MPa) | | | | | | | | |
| Replicate | | | | | | | | |
| 1 | | | | | | | | |
| Strength | 14.1 | 14.7 | 4.52 | 5.08 | 5.68 | 8.38 | 7.49 | 1.3 |
| (MPa) | | | | | | | | |
| Replicate | | | | | | | | |
| 2 | | | | | | | | |
| Strength | 15.3 | 5.72 | 7.46 | 5.8 | 9.55 | 7.75 | 8.18 | 1.97 |
| (MPa) | | | | | | | | |
| Replicate | | | | | | | | |
| 3 | | | | | | | | |
| Mean | 14.3 | 12.5 | 5.84 | 5.54 | 7.23 | 7.13 | 7.92 | 1.59 |

As can be seen the addition of the ionic liquid infused particles to the adhesive system lowered the force required to separate the bonded substrates significantly.

What is claimed is:

1. An ionic liquid-infused particle.

2. The particle of claim 1, wherein the ionic liquid is a salt in the liquid state at room temperature.

3. The particle of claim 1, wherein the ionic liquid is a salt whose melting point is below about 100° C.

4. The particle of claim 1, wherein the ionic liquid is composed either of a salt having a Group IA or IIA element as a cation and a Group VIIA element or a compound comprising one or more Group VIIA element(s) as an anion; optionally, an organic solvent; and optionally, water.

5. The particle of claim 4, wherein the organic solvent is present.

6. The particle of claim 5, wherein the organic solvent is PEG 400, PEG 200, or PEG 600, tetraglyme, tetrahydrofuran (“THF”), dimethyl formamide (“DMF”), hydroxy ethyl acrylate (“HEA”), hydroxy ethyl methacrylate (“HEMA”), methacrylic acid (“MAA”), or acrylamide.

7. The particle of claim 4, wherein water is present.

8. The particle of claim 1, wherein the ionic liquid comprises a salt having an alkali metal selected from the group consisting of lithium, sodium, beryllium, magnesium, iron, copper, aluminum or zinc as a cation, and fluorine, chlorine, oxygen, sulfur, nitrogen, phosphorous, carbon or silicon as an anion.

9. The particle of claim 1, wherein the ionic liquid comprises a salt having an imidazolium, pyridinium, phosphonium, ammonium, morpholinium, allyl cation, or benzyl as a cation, and tetrafluoroborate, hexafluorophosphate, trifluoromethanesulfonate, bis(trifluoromethylsulfonyl)imide (“TFSI”), acetate, carboxylate, phenolate, or sulfonate as an anion.

10. The particle of claim 1, wherein the ionic liquid comprises a salt in an amount of from about 15 percent by weight to about 50 percent by weight; an organic solvent in an amount of from about 50 percent by weight to about 75 percent by weight; and water in an amount of from about 5 percent by weight to about 15 percent by weight.

11. The particle of claim 1, wherein the ionic liquid comprises a salt in an amount of from about 30 percent by weight; an organic solvent in an amount of from about 60 percent by weight; and water in an amount of from about 10 percent by weight.

12. The particle of claim 1, wherein the ionic liquid is present in an amount of from about 50 percent by weight to about 75 percent by weight in the ionic liquid-infused particle and the particle is present in an amount of from about 25 percent by weight to about 50 percent by weight in the ionic liquid-infused particle.

13. The particle of claim 1, wherein the particle has a size within the range of about 50 nm to about 200 microns.

14. The particle of claim 1, wherein the particle is inorganic.

15. The particle of claim 1, wherein the particle is fused silica, calcium carbonate, carbon black, alumina, molecular sieve, clay, titanium dioxide, mica, talc, graphite, and glass particles.

16. The particle of claim 1, wherein the particle has a surface area of about least about 20 m²/g to about 500 m²/g (as determined by BET measurements).

17. The particle of claim 1, wherein the particle is organic.

18. The particle of claim 1, wherein the particle is selected from the group consisting of sawdust, cellulose, PMMA, PS, PP, PET, and nylon.

19. A composition comprising an ionic liquid and a particle, wherein the ionic liquid is infused in or on the particle.

20. A curable composition comprising:
A curable component; and
An ionic liquid-infused particle of claim 1.

21. The composition of claim 20, wherein the curable component is a member selected from the group consisting of (meth)acrylates, epoxies, alkoxy-functionalized siloxanes, silane-functionalized monomers, oligomers and polymers, isocyanato-functionalized monomers, oligomers and polymers and combinations thereof.

22. The composition of claim 20, further comprising a curative.

23. The composition of claim 20, wherein the curable component is present in an amount of from about 25 percent by weight to about 99 percent by weight of the composition; the curative is present in an amount of from about 0.1 percent by weight to about 20 percent by weight of the composition; and the ionic liquid-infused particle is present in an amount of from about 0.9 percent by weight to about 70 percent by weight of the composition, wherein the total amount is 100 percent by weight of the composition.

24. The composition of claim 20, wherein the curable component is present in an amount of from about 25 percent by weight to about 40 percent by weight of the composition; the curative is present in an amount of from about 5 percent by weight to about 20 percent by weight of the composition; and the ionic liquid-infused particle is present in an amount of from about 35 percent by weight to about 65 percent by weight of the composition, wherein the total amount is 100 percent by weight of the composition.

25. The composition of claim 20, wherein the composition is an adhesive or a coating.

26. A method of debonding one or more substrates bonded together by an adhesive composition, comprising the steps of:
Providing an assembly comprising two or more electrically conductive substrates adhesively bonded together at inwardly facing surfaces by a reaction product of the curable composition of claim 20;
Providing a power supply, wherein a first connection is made from the power supply to a first conductive substrate and a second connection is made from the power supply to a second conductive substrate;
Applying to the electrically conductive substrates about 3 volts to about 75 volts of DC current from the power supply for a period of time of about 0.1 seconds to about 3 hours at room temperature;
Separating at least one electrically conductive substrate from the reaction product.

27. The method of claim 26, wherein the application of DC current is 30 volts.

28. The method of claim 26, wherein the period of time is about 0.1 seconds to about 3 hours.

29. The method of claim 26, wherein the temperature is above room temperature.

30. The method of claim 26, wherein the at least one electrically conductive substrate is separated from the reaction product leaving little to no residual reaction product on the surface of the substrate so separated.

31. The method of claim 26, wherein about less than 50% of the force is used to separate the at least one electrically conductive substrate from the reaction product than is needed in the absence of the applied voltage.

32. A method of reversibly adhesively bonding one or more substrates together with a curable composition, comprising the steps of:
Providing one or more electrically conductive substrates;
Providing a curable composition of claim 1 onto at least one surface of at least one of the one or more electrically conductive substrates;
Mating the at least one surface on which is disposed the curable composition with another surface of an electrically conductive substrate and exposing the mated surfaces to conditions favorable to cure the curable composition thereby forming an adhesively bonded assembly;
Providing a power supply and connecting the power supply to the adhesively bonded assembly, wherein a first connection is made from the power supply to a first conductive substrate and a second connection is made from the power supply to a second conductive surface;
Applying to the electrically conductive substrates about 3 volts to about 75 volts from the power supply for a period of time of about 0.1 seconds to about 3 hours at room temperature;
Separating at least one electrically conductive substrate from the cured composition.
